(19) United States
(12) Patent Application Publication
(10) Pub. No.: US 2023/0120845 A1
(43) Pub. Date: Apr. 20, 2023

(54) ALUMINUM ALLOY SUBSTRATE FOR MAGNETIC DISK, AND MAGNETIC DISK USING SAME

(71) Applicants: UACJ CORPORATION, Tokyo (JP); FURUKAWA ELECTRIC CO., LTD., Tokyo (JP)

(72) Inventors: Kotaro KITAWAKI, Chiyoda-ku, Tokyo (JP); Wataru KUMAGAI, Chiyoda-ku, Tokyo (JP); Ryo SAKAMOTO, Chiyoda-ku, Tokyo (JP); Hideyuki HATAKEYAMA, Chiyoda-ku, Tokyo (JP)

(21) Appl. No.: 17/907,490

(22) PCT Filed: Apr. 6, 2021
(86) PCT No.: PCT/JP2021/014657

§ 371 Date: Sep. 27, 2022

(30) Foreign Application Priority Data
Apr. 6, 2020 (JP) 2020-068369

(51) Int. Cl. G11B 5/73; C23C 18/32; C22C 21/08; C22F 1/047

(52) U.S. Cl. CPC G11B 5/73919; C23C 18/32; C22C 21/08; C22F 1/047

(57) ABSTRACT

An aluminum alloy substrate for magnetic disks, including an aluminum alloy containing: 1.0 to 6.5 mass % of Mg; and the balance consisting of Al and unavoidable impurities, in which the distribution of Si—K—O-based particles with a longest diameter of 1 μm or more adhering to the surface from the surrounding environment is equal to or less than one particle/6,000 mm²; and in which the distribution of Ti—B-based particles with a longest diameter of 1 μm or more present on the surface is equal to or less than one particle/6,000 mm², and a magnetic disk using the aluminum alloy substrate for magnetic disks.

### TECHNICAL FIELD

The present disclosure relates to an aluminum alloy substrate for magnetic disks with excellent impact resistance and excellent Ni—P plating film smoothness, and a magnetic disk using said aluminum alloy substrate for magnetic disks.

### BACKGROUND ART

Hard disk drives (hereinafter abbreviated as “HDDs”) are widely used as storage devices in electronic equipment such as computers and video recorders. HDDs have an incorporated magnetic disk for recording data. Magnetic disks comprise a magnetic disk substrate made of aluminum alloy and having circular shape, a Ni—P plating film covering the surface of the magnetic disk substrate, and a magnetic layer layered on the Ni—P plating film.

In recent years, the amount of information recorded on HDDs has been increasing in both applications for business use, such as servers and data centers, and for home use, such as personal computers and video recorders. In order to increase the capacity of HDDs in response to such situations, there is a demand to increase the recording density of magnetic disks incorporated in HDDs. To increase the recording density of a magnetic disk, it is necessary to form a smooth Ni—P plating film on the magnetic disk substrate.

Magnetic disks are generally produced by the following method. First, an aluminum alloy rolled sheet is punched into a circular shape to make a disk blank. Next, the disk blank is heated while being pressurized from both sides in the thickness direction to reduce the warpage of the disk blank. Then, the disk blank is subjected to cutting and grinding into a desired shape to obtain a magnetic disk substrate. A magnetic disk can be produced by sequentially subjecting the thus-obtained magnetic disk substrate to pretreatment to form a Ni—P plating film, an electroless Ni—P plating process, and sputtering for the magnetic layer.

JIS A5086 alloy is widely used as an aluminum alloy used for magnetic disk substrates. However, when the disk blank is produced using a composition range of common JIS A5086 alloys, relatively large intermetallic compounds may be formed in the Al matrix. Such intermetallic compounds may fall out of the Al matrix during cutting, grinding, and pretreatment to form a Ni—P plating film.

When intermetallic compounds fall off from the Al matrix, relatively large dents are formed on the magnetic disk substrate. If intermetallic compounds that have fallen off from the magnetic disk substrate are sandwiched between a tool and the magnetic disk substrate during cutting or grinding, scratches may be formed in the magnetic disk substrate. When an electroless Ni—P plating process is performed under such conditions, dents and scratches on the magnetic disk substrate may cause formation of plating pits, resulting in deteriorated smoothness of the Ni—P plating film.

In order to further improve the smoothness of Ni—P plating films, various technologies have been studied to reduce foreign substances such as intermetallic compounds in magnetic disk substrates. For example, Patent Literature 1 describes a method of manufacturing an Al-based alloy sheet for magnetic disks, comprising continuously casting molten Al-based alloy essentially containing 2 to 6% Mg, 1% or less of Mn, 0.3% or less of Fe, 0.25% or less of Zn, and 0.35% or less of Cr into a sheet thickness of 4 to 15 mm, and further rolling it.

Patent Literature 2 describes a processing method for aluminum or aluminum alloy in which B in an amount 100 to 200 mass ppm more than the total chemical equivalent calculated as TiB2 and ZrB2 is added to molten aluminum or aluminum alloy containing Ti and Zr as impurities.

### CITATION LIST

### Patent Literature

Patent Literature 1: Unexamined Japanese Patent Application Publication No. S56-105846

Patent Literature 2: Unexamined Japanese Patent Application Publication No. 2002-173718

According to the manufacturing method in Patent Literature 1, the thickness of the sheet material during casting can be thinner to increase the cooling rate of the molten metal when solidified and refine Al—Fe—Mn intermetallic compounds. However, it is difficult to sufficiently refine inclusions other than Al—Fe—Mn intermetallic compounds by the manufacturing method in Patent Literature 1.

The treatment method according to the Patent Literature 2 involves an aluminum casting step in which B is added in an excess amount relative to Ti and Zr in the molten Al-based alloy, and inclusions such as TiB2 and ZrB2 formed by the reaction with B are removed. However, the method according to Patent Literature 2 has an adverse effect on foreign substances other than Ti—B and Zr—B.

Furthermore, there are no detailed reports on the causes of or methods for dealing with the adhesion of dust and other substances from the surrounding environment to the surface of the aluminum sheet during the aluminum sheet manufacturing process.

### SUMMARY OF INVENTION

### Technical Problem

The present disclosure has been made in view of the above-described problems, and the present inventors have found that an aluminum alloy substrate for magnetic disks having excellent Ni—P plating film smoothness achieved by preventing the adhesion of coarse Ti—B-based particles formed from unavoidable impurities contained in aluminum alloys, and Si—K—O-based particles contained in dust and the like from the surrounding environment during the manufacturing process to the surface of the aluminum alloy substrate, thereby completing the present disclosure.

### Solution to Problem

Accordingly, the present disclosure of claim 1 is an aluminum alloy substrate for magnetic disks, comprising an aluminum alloy containing:

1.0 to 6.5 mass % of Mg; and

the balance consisting of Al and unavoidable impurities,

wherein

the distribution of Si—K—O-based particles with a longest diameter of 1 μm or more adhering to the surface from the surrounding environment is equal to or less than one particle/6,000 mm², and

the distribution of Ti—B-based particles with a longest diameter of 1 μm or more present on the surface is equal to or less than one particle/6,000 mm².

The present invention of claim 2 is the aluminum alloy substrate for magnetic disks of claim 1, wherein the aluminum alloy further contains one or more selected from the group consisting of 0.300 mass % or less of Cu, 0.60 mass % or less of Zn, 0.600 mass % or less of Fe, 0.600 mass % or less of Si, 0.0020 mass % or less of Be, 0.20 mass % or less of Cr, 1.70 mass % or less of Mn, 0.20 mass % or less of Zr, 0.10 mass % or less of Sr, 0.10 mass % or less of Na, and 0.10 mass % or less of P.

The present disclosure of claim 3 is a magnetic disk comprising:

an aluminum alloy substrate for magnetic disks of claim 1 or 2;

an electroless Ni—P plated layer provided on the surface of the aluminum alloy substrate; and

a magnetic layer provided on the electroless Ni—P plated layer to obtain.

### Advantageous Effects of Invention

The aluminum alloy substrate for magnetic disks according to the present disclosure can have a Ni—P plating film formed with less plating pits and higher smoothness by preventing production of Si—K—O-based particles and Ti—B-based particles with a longest diameter of 1 μm or more, and thereby reducing damage to the substrate surface due to falling off of these particles.

### BRIEF DESCRIPTION OF DRAWINGS

FIG. 1 is a scanning ion micrograph showing a cross section of an aluminum alloy substrate after plating.

### DESCRIPTION OF EMBODIMENTS

A. Aluminum Alloy Substrate for Magnetic Disks

An aluminum alloy substrate for magnetic disks according to the present disclosure (hereinafter may be referred to as “aluminum alloy substrate”) is described below. An aluminum alloy substrate is obtained by preparing an aluminum alloy sheet using an aluminum alloy with a predetermined alloy composition, punching it into a disk blank, and subjecting it to pressure planarization, cutting and grinding.

A-1. Alloy Composition of Aluminum Alloy Sheet

The composition of the aluminum alloy used in the aluminum alloy sheet and the reasons for the limitation are described in detail below.

Mg: 1.0 to 6.5 mass %

Mg is contained in the aluminum alloy as an essential element and mainly exerting an effect of improving the strength of the aluminum alloy substrate. Further, Mg enables a zincate film to be formed evenly, thinly, and densely in zincate treatment, thereby improving the smoothness of the plating surface of Ni—P in the plating step following the zincating step. However, when the amount of Mg is less than 1.0 mass % (hereinafter referred to as simply “%”), the strength is insufficient, resulting in deformation during cutting, grinding, or other processing. Furthermore, the zincate film formed by zincate treatment is uneven, resulting in deteriorated adhesion and smoothness of the plating film. On the other hand, when the amount of Mg is more than 6.5%, coarse Al—Mg intermetallic compounds are generated, which would fall off during etching, zincating, cutting, or grinding to create large dents, resulting in deterioration of the smoothness of the plating surface. In addition, too many amount of Mg results in higher strength of the aluminum alloy substrate, in which cracks may occur during rolling. Thus, the amount of Mg is defined as from 1.0 to 6.5%. The amount of Mg is preferably from 3.0 to 5.0%, and more preferably from 3.5 to 4.5%, in view of the balance between the strength and manufacturability.

In addition to Mg, the aluminum alloy may further contain one or more additional selective element selected from the group consisting of Cu, Zn, Fe, Si, Be, Cr, Mn, Zr, Sr, Na, and P.

Cu: 0.300% or Less

The aluminum alloy may contain 0.300% or less of Cu as a selective element. Cu has an effect of preventing elution of Al from the aluminum alloy substrate in zincate treatment during a manufacturing process of magnetic disks. When the amount of Cu is 0.300% or less, a dense and thin Zn film with small variation in the thickness can be formed on the surface of the aluminum alloy substrate in zincate treatment during a manufacturing process of magnetic disks. Formation of such a Zn film enables formation of a smooth Ni—P plating film in the subsequent electroless Ni—P plating process.

However, too many amount of Cu causes deterioration of the corrosion resistance of the aluminum alloy substrate, leading to formation of local areas where elution of Al tends to occur. This causes a variation in the amount of Al dissolved from the surface of the aluminum alloy substrate in zincate treatment during a manufacturing process of magnetic disks, resulting in tendency of larger variation in the thickness of the Zn film. This may result in deterioration of the adhesion between the Ni—P plating film and the aluminum alloy substrate and deterioration of the smoothness of the Ni—P plating film.

Inclusion of Cu in the aluminum alloy in an amount of 0.300% or less, preferably 0.150% or less can prevent formation of plating pits, and further increase the smoothness of the Ni—P plating film. The lower limit of the amount of Cu is preferably 0.005%, and more preferably 0.010%. The amount of Cu may be 0% (0.000%).

Zn: 0.60% or Less

The aluminum alloy may contain 0.60% or less of Zn as a selective element. Like Cu, Zn has an effect of preventing elution of Al from the aluminum alloy substrate in zincate treatment. When the amount of Zn is 0.60% or less, a dense and thin Zn film with small variation in the thickness can be formed on the surface of the aluminum alloy substrate in zincate treatment during a manufacturing process of magnetic disks. Formation of such a Zn film enables formation of a smooth Ni—P plating film in the subsequent electroless Ni—P plating process.

However, too many amount of Zn causes deterioration of the corrosion resistance of the aluminum alloy substrate, leading to formation of local areas where elution of Al tends to occur. This causes a variation in the amount of Al dissolved from the surface of the aluminum alloy substrate in zincate treatment during a manufacturing process of magnetic disks, resulting in tendency of larger variation in the thickness of the Zn film. This may result in deterioration of the adhesion between the Ni—P plating film and the aluminum alloy substrate and deterioration of the smoothness of the Ni—P plating film.

Inclusion of Zn in the aluminum alloy in an amount of 0.60% or less, preferably 0.50% or less can prevent formation of plating pits, and further increase the smoothness of the Ni—P plating film. The lower limit of the amount of Zn is preferably 0.10%, and more preferably 0.25%. The amount of Zn may be 0% (0.00%).

Fe and Si: 0.600% or Less

The aluminum alloy may contain 0.600% or less of Fe and Si as selective elements. Fe hardly dissolves in the Al matrix, but is dispersed in the aluminum alloy substrate as an Al—Fe intermetallic compound. When Mg is contained in the aluminum alloy, Si together with Mg forms a Mg—Si intermetallic compound.

When such Al—Fe and Mg—Si intermetallic compounds fall off from the surface of the aluminum alloy substrate, plating pits tend to be formed during the downstream electroless Ni—P plating process. Inclusion of Fe and Si in the aluminum alloy each in an amount of 0.600% or less, preferably 0.050% or less, or more preferably 0.001% or less can further reduce the amount of the intermetallic compounds as described above present in the aluminum alloy substrate. As a result, formation of plating pits can be prevented, and the smoothness of the Ni—P plating film can be further improved.

To prevent generation of plating pits due to the intermetallic compounds as described above, it is preferable that the amounts of Fe and Si are smaller. However, these elements are contained not only in ingots with common purities, but also in high-purity ingots with Al purities of 99.9% by mass or more. Thus, preparation of an aluminum alloy substrate with little or no Fe or Si contained would require specific processings to remove these elements during casting, leading to increase of the manufacturing cost of the aluminum alloy substrate.

When the amounts of Fe and Si contained in the aluminum alloy are 0.050% or less, and preferably 0.001% or less, an aluminum alloy substrate can be prepared without performing any special processings to remove these elements. As a result, the smoothness of the Ni—P plating film can be further improved while avoiding an increase of the manufacturing cost of the aluminum alloy substrate. When the amounts of Fe and Si in the aluminum alloy are more than 0.050%, but are 0.600% or less, ingots with lower purities can be used to prepare the aluminum alloy substrate. This can further reduce the material cost of the aluminum alloy substrate. The amounts of Fe and Si may be 0% (0.000%).

Be: 0.0020% or Less

Be is an element that is added to molten metal in casting an Mg-containing aluminum alloy in order to prevent oxidation of Mg. In addition, when the amount of Be contained in the aluminum alloy is 0.0020% or less, Zn film that is formed on the aluminum alloy substrate during the manufacturing process of magnetic disks can be denser, while having thickness with reduced variation. This further improves the smoothness of the Ni—P film formed on the aluminum alloy substrate.

However, too many amount of Be in the aluminum alloy facilitates formation of Be oxide on the surface of a disk blank when the disk blank is heated during the manufacturing process of the aluminum alloy substrate. When Mg is further contained in the aluminum alloy, it facilitates formation of Al—Mg—Be oxide on the surface of a disk blank when the disk blank is heated. Higher amounts of these oxides may cause larger variation in the thickness of the Zn film, and generation plating pits.

Inclusion of Be in the aluminum alloy in an amount of 0.0020% or less, preferably 0.0010% or less can reduce the amount of Al—Mg—Be oxide, and further increase the smoothness of the Ni—P plating film. The lower limit of the amount of Be may be 0% (0.0000%), but preferably is 0.0002%.

Cr: 0.20% or Less

The aluminum alloy may contain 0.20% or less of Cr as a selective element. Some Cr disperses in the aluminum alloy substrate as fine intermetallic compounds generated during casting. Cr that has not formed intermetallic compounds during casting is dissolved in the Al matrix, exhibiting an effect of improving the strength of the aluminum alloy substrate via solid solution strengthening.

Cr also has effects of improving the cutting and grinding properties, while making the recrystallized structure finer. This further improves the adhesion between the aluminum alloy substrate and the Ni—P plating film, and prevents generation of plating pits.

However, too many amount of Cr in the aluminum alloy facilitates formation of coarse Al—Cr intermetallic compounds in the aluminum alloy substrate. When such coarse Al—Cr intermetallic compounds fall off from the surface of the aluminum alloy substrate, plating pits tend to be formed during the downstream electroless Ni—P plating process.

Inclusion of Cr in the aluminum alloy in an amount of 0.20% or less, preferably 0.10% or less, can prevent formation of plating pits to allow for formation of a smooth Ni—P plating film, while further improving the strength of the aluminum alloy substrate. The lower limit of the amount of Cr is preferably 0.03%, and more preferably 0.05%. The amount of Cr may be 0% (0.00%).

Mn: 1.70% or Less

The aluminum alloy may contain 1.70% or less of Mn as a selective element. Some Mn disperses in the aluminum alloy substrate as fine intermetallic compounds generated during casting. Mn that has not formed intermetallic compounds during casting is dissolved in the Al matrix, exhibiting an effect of improving the strength of the aluminum alloy substrate via solid solution strengthening.

Mn also has effects of improving the cutting and grinding properties, while making the recrystallized structure finer. This further can improve the adhesion between the aluminum alloy substrate and the Ni—P plating film, and prevent generation of plating pits.

However, too many amount of Mn in the aluminum alloy facilitates formation of coarse Al—Mn intermetallic compounds in the aluminum alloy substrate. When such coarse Al—Mn intermetallic compounds fall off from the surface of the aluminum alloy substrate, plating pits tend to be formed during the downstream electroless Ni—P plating process.

Thus, inclusion of Mn in the aluminum alloy in an amount of 1.70% or less, preferably 1.20% or less, can prevent formation of plating pits to allow for formation of a smooth Ni—P plating film, while further improving the strength of the aluminum alloy substrate. The lower limit of the amount of Mn is preferably 0.10%, and more preferably 0.15%. The amount of Mn may be 0% (0.00%).

Zr: 0.20% or Less

The aluminum alloy may contain 0.20% or less of Zr as a selective element. Some Zr disperses in the aluminum alloy substrate as fine intermetallic compounds generated during casting. Zr that has not formed intermetallic compounds during casting is dissolved in the Al matrix, exhibiting an effect of improving the strength of the aluminum alloy substrate via solid solution strengthening.

Zr also has effects of improving the cutting and grinding properties, while making the recrystallized structure finer. This further improves the adhesion between the aluminum alloy substrate and the Ni—P plating film, and prevents generation of plating pits.

However, too many amount of Zr in the aluminum alloy facilitates formation of coarse Al—Zr intermetallic compounds in the aluminum alloy substrate. If such coarse Al—Zr intermetallic compounds fall off from the surface of the aluminum alloy substrate, plating pits would tend to be formed during the downstream electroless Ni—P plating process.

Inclusion of Zr in the aluminum alloy in an amount of 0.20% or less can prevent formation of plating pits to allow for formation of a smooth Ni—P plating film, while further improving the strength of the aluminum alloy substrate. The lower limit of the amount of Zr is preferably 0.03%, and more preferably 0.05%. The amount of Zr may be 0% (0.00%).

Sr, Na, and P: Each 0.10% or Less

Sr, Na, and P have an effect of making second-phase particles (mainly Si particles) in the aluminum alloy substrate finer to improve the plating properties. Sr, Na, and P also have an effect of reducing the unevenness in the size of second-phase particles in the aluminum alloy substrate to reduce variation in the impact resistance. Thus, the aluminum alloy may contain Sr, Na, and P in a respective amount of 0.10% or less.

However, even when Sr, Na, and P are each contained in an amount of more than 0.10%, the effects described above are saturated without further significant effects. In addition, to obtain the effects described above, the lower limit of each amount of Sr, Na, and P is preferably 0.001%. Each amount of Sr, Na, and P may be 0% (0.000%).

Other Elements

The aluminum alloy may contain other elements that are unavoidable impurities than the essential component and selective components as described above. Examples of the elements include Ti, B, Si, and Ga. When the amounts of the elements other than B are each 0.05% or less, and the total amount is 0.15% or less, then the effects of the present disclosure are not impaired. When the amount of B is 0.0015% or less, then the effects of the present disclosure are not impaired. It is noted that when Ti and B are contained, “Ti—B-based particles” are formed as described below. As described above, Si may actively or may not be added as a selective component in the present disclosure. Si, as described above, is contained as an unavoidable impurity not only in bullion of general purity but also in high-purity bullion with an Al purity of 99.9% or more. Even when Si is contained as such an unavoidable impurity, the effect of the present disclosure is not impaired as long as the amount is 0.050% or less (preferably 0.001% or less) as described above.

A-2. Method of Manufacturing Aluminum Alloy Sheet

(1) Casting Step

The raw materials for an aluminum material of the alloy composition as described above are melted to produce molten metal, which is then cast to prepare an ingot. The casting method used may be a direct chill casting (DC casting) method, a metal mold casting method, or a continuous casting (CC casting) method. In a DC casting method, molten metal poured through a spout is deprived of heat by a bottom block, water-cooled mold walls, and cooling water discharged directly to the ingot periphery, solidified, and drawn downward as an ingot. In a metal mold casting method, molten metal is poured into a hollow metal mold made of cast iron or the like, deprived of heat by the walls of the metal mold, and is solidified, while in a CC casting method for producing ingots, molten metal is supplied from a casting nozzle passing between a pair of rolls (or belt caster, block caster), and deprived of heat by the rolls to directly cast a sheet.

In such a casting step, degassing for reducing dissolved gas in the molten metal and filtering for removing solids in the molten metal are performed in an in-line manner.

In such a casting step, degassing for reducing dissolved gas in the molten metal and filtering for removing solids in the molten metal are performed in an in-line manner. For degassing, for example, processing methods such as called spinning nozzle inert flotation (SNIF) process and Alpur process can be used. These processes involve forming minute bubbles of process gas in the molten metal by blowing in process gas such as argon gas or a mixed gas of argon and chlorine while the molten metal is stirred at high speed by a bladed rotor. This enables removal of hydrogen gas and inclusions dissolved in the molten metal in a short time period. For degassing, in-line degassing equipment can be used.

For filtering, for example, a filtration method through cakes or filter media can be used. For filtering, for example, filters such as ceramic tube filters, ceramic foam filters, and alumina ball filters can be used.

(2) Homogenization Step

After an ingot is produced and before hot rolling, the ingot may be subjected to a facing process, as necessary, for homogenization. The holding temperature in homogenization can be appropriately set, for example, from 500 to 600° C. The holding time in homogenization can be appropriately set, for example, from 1 to 60 hours.

(3) Hot Rolling Step

Next, the ingot is subjected to hot rolling to produce a hot rolled sheet. The rolling conditions for hot rolling are not particularly limited, and for example, hot rolling can be performed by setting the starting temperature in the range of 400 to 600° C. and the ending temperature in the range of 260 to 380° C.

(4) Cold Rolling Step

After hot rolling, the obtained hot rolled sheet is subjected to one or more passes of cold rolling to obtain a cold rolled sheet. The rolling conditions for cold rolling are not particularly limited, and may be set appropriately according to the desired thickness and strength of the aluminum alloy substrate. For example, the total draft in cold rolling can be from 20 to 95%. The thickness of the cold rolled sheet can be set appropriately, for example, from 0.2 to 1.9 mm.

(5) Annealing Step

In the manufacturing method in the above manner, annealing may be performed at at least one of before the first pass or between passes during cold rolling, as necessary. Annealing may be performed using a batch heat treat furnace or a continuous heat treat furnace. When using a batch heat treat furnace, the holding temperature and the holding time in annealing are preferably from 250 to 430° C. and from 0.1 to 10 hours, respectively. When using a continuous heat treat furnace, the time to stay in the furnace is preferably 60 seconds or less, and the temperature in the furnace is preferably from 400 to 600° C. Annealing under such conditions can recover the workability during cold rolling.

Aluminum alloy sheets are produced by the above steps.

A-3. Method of Manufacturing Aluminum Alloy Substrate

In manufacturing an aluminum alloy sheet from the aluminum alloy substrate described above, for example, the following method can be employed. The aluminum alloy sheet is punched to obtain a disk blank having a circular shape. Then, the disk blank is heated while being pressurized from both sides in the thickness direction for pressure annealing, to reduce the warpage of the disk blank and improve the flatness. The holding temperature and the pressure in pressure annealing can be appropriately selected, for example, from 250-430° C., and from 1.0-3.0 MPa, respectively. The holding time in pressure annealing can be, for example, 30 minutes or more.

After pressure annealing, the disk blank is sequentially subjected to cutting and grinding to produce an aluminum alloy substrate having a desired shape. After these processings, thermal straightening may be performed as necessary at 150 to 350° C. for 0.1 to 5.0 hours to remove strains due to the processings.

Aluminum alloy substrates are produced by the above steps.

A-4. Particles Present on the Surface of Aluminum Alloy Substrate

Particles that are mixed in from the surrounding environment during the manufacturing process of aluminum alloy sheets and aluminum alloy substrates as described below, as well as particles derived from aluminum alloy components, are present on the surface of the aluminum alloy substrate. Among these particles, coarse ones with the longest diameter of 1 μm or more create large dents on the surface of the aluminum alloy substrate when they fall off from the surface during the manufacturing process of magnetic disks. Furthermore, those that fall off from the surface during cutting and grinding are dragged between the tool and the aluminum alloy substrate, scratching the surface of the aluminum alloy substrate. When an electroless Ni—P plating process is performed in the presence of such dents and scratches, plating pits are formed on the surface of the Ni—P plating film, and the smoothness of the Ni—P plating film is impaired. Therefore, it is necessary to prevent the formation of such coarse particles. The present inventors have found that such coarse particles include Si—K—O-based particles that are mixed in from the surrounding environment and Ti—B-based particles derived from aluminum alloy components.

(1) Si—K—O-Based Particles on the Surface of Aluminum Alloy Substrate

Si—K(potassium)-O(oxygen)-based particles are dispersed on the surface of the aluminum alloy substrate. Among the Si—K—O-based particles present on the surface of the aluminum alloy substrate, the number of Si—K—O-based particles with the longest diameter of 1 μm or more is controlled to be equal to or less than 1/6,000 mm².

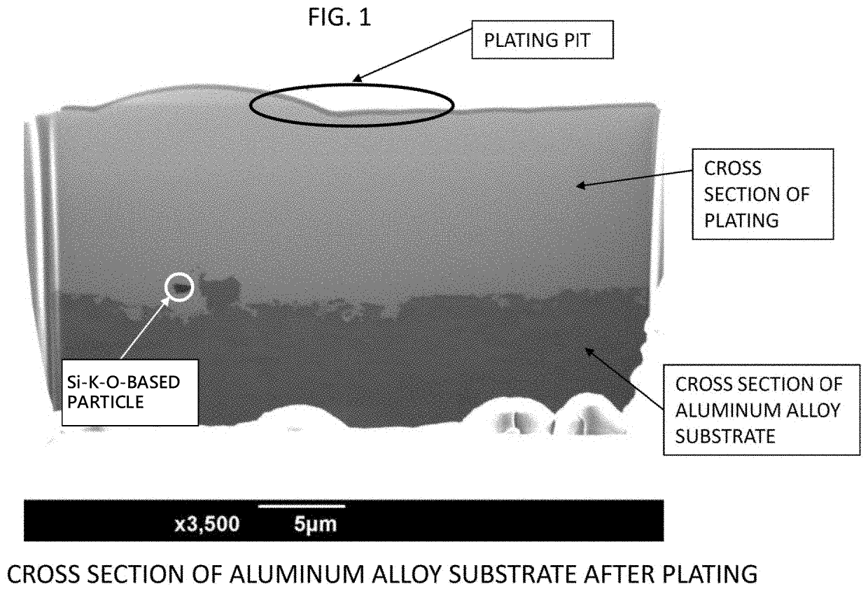

When the number of Si—K—O-based particles with the longest diameter of 1 μm or more are more than 1/6,000 mm², it means that coarse Si—K—O-based particles are present on the surface of the aluminum alloy substrate. Then, such Si—K—O-based particles, when fall off from the surface during the manufacturing process of magnetic disks, cause formation of large dents on the surface of the aluminum alloy substrate. Furthermore, when Si—K—O-based particles that fall off from the surface during cutting and grinding are dragged between the tool and the aluminum alloy substrate, scratches may be created on the surface of the aluminum alloy substrate. When an electroless Ni—P plating process is performed in the presence of such dents and scratches, plating pits are easily formed on the surface of the Ni—P plating film. FIG. 1 is a scanning ion micrograph showing a cross section of an aluminum alloy substrate after plating, demonstrating that the presence of Si—K—O-based particles results in formation of plating pits. FIG. 1 is further described as follows. Si—K—O-based particles as shown in the FIGURE were present at the position of the plating pit shown at the top of the FIGURE. Some of the particles fell off from the surface during the manufacturing process of magnetic disks to form dents. The dents cause formation of plating pits on the surface of the Ni—P plating film in the subsequent electroless Ni—P plating process.

When the number of Si—K—O-based particles with the longest diameter of 1 μm or more is 1/6,000 mm² or less, production of coarse Si—K—O-based particles in the aluminum alloy substrate is prevented. This enables formation of a Ni—P plating film with less plating pits and high smoothness in an electroless Ni—P plating process. From the viewpoint of further improving the smoothness of the Ni—P plating film, it is preferable that Si—K—O-based particles with the longest diameter of 1 μm or more are not present on the surface of the aluminum alloy substrate, or the number is 0/6,000 mm². Alternatively, even when Si—K—O-based particles are present on the surface of the aluminum alloy substrate, there is no problem if the longest diameter is less than 1 μm. When the longest diameter is less than 1 μm, dents and scratches formed on the surface as described above are small, and plating pits formed by them on the surface of the Ni—P plating film are also small without risk of causing any problems.

Si—K—O-based particles are dust and the like that exist in the environments surrounding the rollers and punchers (hereinafter referred to as “surrounding environments”) during processes using rolls, such as rolling and leveling, during disk blank punching, and other processes in manufacturing aluminum alloy sheets; drift to the surface of the aluminum alloy sheet due to air convection, equipment vibration, and the like; and finally adhere to the surface of the aluminum alloy substrate through subsequent processes. In the present disclosure, such Si—K—O-based particles are referred to as Si—K—O-based particles adhering to the surface from the surrounding environment.

In particular, when hot rolling or cold rolling rolls are used in manufacturing aluminum alloy sheets, the vibration caused by the operation of the rolls causes dust and the like present in the surrounding environment to adhere to the surface of the rolled sheet, and embedded in the surface during subsequent processes. In addition, in punching disk blanks from aluminum alloy sheets, the vibration caused by intermittent punching causes dust and the like to adhere to the surface, and embedded in the surface during subsequent pressure annealing. It is difficult to completely remove dust and the like that adhered during using rolls or punching, but as described above, Si—K—O-based particles having a longest diameter of less than 1 μm do not affect the smoothness of the Ni—P plating film. Installation of protective covers around the equipment, and of the equipment in an environment containing less dust and the like are effective means to prevent generation of Si—K—O-based particles. Polyvinyl chloride, an acrylic resin, glass, or the like is preferably used as the protective cover. When the distance between the protective cover and the equipment is too far, the effect of preventing contamination may be small, whereas when the distance is too close, foreign substances adhering to the protective cover may fall and are mixed in. Thus, the distance between the protective cover and the equipment is preferably from 0.5 to 6.0 m, and more preferably from 1.0 to 5.5 m.

The above-described measures can greatly reduce the generation of Si—K—O-based particles, and further preferably a chemically treatment is performed in case Si—K—O-based particles are mixed in small quantities. The chemical treatment, when performed, is preferably done before grinding. The chemical treatment is preferably performed using an aqueous solution such as sulfuric acid. When the concentration of the chemical treatment solution is less than 0.1%, the removal of Si—K—O-based particles may be insufficient. When the concentration is more than 1.0% or when the temperature of the chemical treatment solution is higher than 40° C., the reaction becomes active and pores may open on the surface of the sheet, resulting in deteriorated smoothness of the plated surface. Therefore, cleaning is preferably performed using a chemical treatment solution with a concentration of 0.1 to 1.0% at a temperature of 40° C. or lower. The concentration of the chemical treatment solution is preferably in the range of 0.2 to 0.8%, and the temperature is preferably 30° C. or lower. When the temperature is 5° C. or lower, the obtained effect of removing Si—K—O-based particles is insufficient. The treatment time period for the chemical cleaning is preferably 5 seconds or longer. When the treatment time period is too short, the removal of Si—K—O-based particles may be insufficient. The upper limit of the treatment time period is not particularly provided. However, too long treatment time period makes the manufacturing cost higher, and thus the upper limit of the treatment time period is about 100 seconds.

Si—K—O-based particles adhered to the surface of the aluminum alloy substrate in this manner refer to particles from which Si, K and 0 are detected in elementary analysis using a scanning electron microscope (SEM) having an energy dispersive X-ray spectrometer (EDS). The longest diameter of a Si—K—O-based particle is defined herein as the distance between two most distant points on Distance between the two most distant points on the outline of a Si—K—O-based particle in an SEM image of the surface of the aluminum alloy substrate.

A-5. Ti—B-Based Particles on the Surface of Aluminum Alloy Substrate

Ti—B-based particles are dispersed on the surface of the aluminum alloy substrate. Among the Ti—B-based particles present on the surface of the aluminum alloy substrate, the number of Ti—B-based particles with the longest diameter of 1 μm or more is controlled to be equal to or less than 1/6,000 mm².

When the number of Ti—B-based particles with the longest diameter of 1 or more are more than 1/6,000 mm², it means that coarse Ti—B-based particles are present on the surface of the aluminum alloy substrate. Then, such Ti—B-based particles, when fall off from the surface during the manufacturing process of magnetic disks, cause formation of large dents on the surface of the aluminum alloy substrate. Furthermore, when Ti—B-based particles that fall off from the surface during cutting and grinding are dragged between the tool and the aluminum alloy substrate, scratches may be created on the surface of the aluminum alloy substrate. When an electroless Ni—P plating process is performed in the presence of such dents and scratches, plating pits are easily formed on the surface of the Ni—P plating film.

When the number of Ti—B-based particles with the longest diameter of 1 or more is 1/6,000 mm² or less, production of coarse Ti—B-based particles in the aluminum alloy substrate is prevented. This enables formation of a Ni—P plating film with less plating pits and high smoothness in an electroless Ni—P plating process. From the viewpoint of further improving the smoothness of the Ni—P plating film, it is preferable that Ti—B-based particles with the longest diameter of 1 μm or more are not present on the surface of the aluminum alloy substrate, or the number is 0/6,000 mm². Alternatively, even when Ti—B-based particles are present on the surface of the aluminum alloy substrate, there is no problem if the longest diameter is less than 1 When the longest diameter is less than 1 dents and scratches formed on the surface as described above are small, and plating pits formed by them on the surface of the Ni—P plating film are also small without risk of causing any problems.

At least the case of Ti—B-based particles containing both Ti and B is different from the Si—K—O-based particles as described above, and Ti—B-based particles are formed, by Ti and B contained as unavoidable impurities in the aluminum alloy used, in the manufacturing process of aluminum alloy sheets, such as in the melting process of molten aluminum alloy, and finally formed in the aluminum alloy substrate, including the surface, through subsequent processes. It is difficult to completely remove such Ti—B-based particles, but as described above, Ti—B-based particles having a longest diameter of less than 1 μm do not affect the smoothness of the Ni—P plating film. As a means to reduce production of Ti—B-based particles, use of raw materials containing less amounts of Ti and B is effective. Thus, the amounts of Ti and B contained as unavoidable impurities in the aluminum alloy are preferably limited to 0.05% or less and 0.0015% or less, respectively.

Ti—B-based particles adhered to the surface of the aluminum alloy substrate in this manner refer to particles from which Ti and B are detected in elementary analysis using a scanning electron microscope (SEM) having an energy dispersive X-ray spectrometer (EDS). The longest diameter of a Ti—B-based particle is defined herein as the distance between two most distant points on Distance between the two most distant points on the outline of a Ti—B-based particle in an SEM image of the surface of the aluminum alloy substrate.

B. Magnetic Disk

B-1. Configuration of Magnetic Disk

Magnetic disks comprising the aluminum alloy substrate as described above have the following exemplary configuration. Namely, magnetic disks comprise an aluminum alloy substrate, a Ni—P plating film covering the surface of the aluminum alloy substrate, and a magnetic layer layered on the Ni—P plating film.

The magnetic disk may further have a protective layer made of carbon-based material such as diamond-like carbon and layered on the magnetic layer, and a lubricating layer made of lubricating oil and applied on the protective layer.

B-2. Method of Manufacturing Magnetic Disk

In manufacturing magnetic disks from aluminum alloy substrates, for example, the following method can be employed. First, the aluminum alloy substrate is degreased to remove oils such as machining oil adhering to the surface of the aluminum alloy substrate. After degreasing, etching may be performed, as necessary, on the aluminum alloy substrate using and acid. When etching is performed, it is preferable to perform desmutting treatment after etching to remove the smut produced by the etching from the aluminum alloy substrate. The treatment conditions for these treatments can be set appropriately according to the types of the treatment solutions.

After these pre-plating treatments, zincate treatment is performed to form a Zn film on the surface of the aluminum alloy substrate. In the zincate treatment, Al is substituted by Zn for zinc displacement plating, which can form a Zn film. The zincate treatment that is preferably used is a so-called double zincating process comprising performing first zinc displacement plating, then peeling off the Zn film formed on the surface of the aluminum alloy substrate, and again performing zinc displacement plating to form a Zn film. The double zincating process enables formation of a denser Zn film on the surface of an aluminum alloy substrate as compared to a Zn film only formed by first zinc displacement plating. This can reduce defects in the Ni—P plating film in the subsequent electroless Ni—P plating process.

After zincate treatment to form a Zn film on the surface of an aluminum alloy substrate, an electroless Ni—P plating process can be performed to substitute the Zn film by a Ni—P plating film. As described above, smaller amounts of coarse Si—K—O-based particles and Ti—B-based particles on the surface of the aluminum alloy substrate would result in formation of a denser and thinner Zn film with less variation in the thickness on the surface of the aluminum alloy substrate after zincate treatment. Finally, such a Zn film can be substituted by a Ni—P plating film in an electroless Ni—P plating process to form a Ni—P plating film that have fewer plating pits and thus is smoother.

When the thickness of the Ni—P plating film is increased, a smaller number of plating pits tend to be formed, and thus a smoother Ni—P plating film can be formed. Thus, the plating thickness is preferably 7 μm or more, more preferably 18 μm or more, and still more preferably 25 μm or more. Practically, the upper limit of the plating thickness is about 40 μm.

After the electroless Ni—P plating process, the Ni—P plating film can be polished to further improve the smoothness of the surface of the Ni—P plating film.

After the electroless Ni—P plating process (including polishing), magnetic substances are adhered onto the Ni—P plating film by sputtering to form a magnetic layer. The magnetic layer may be composed of a single layer or multiple layers with different compositions from each other. After sputtering, CVD is performed to form a protective layer composed of a carbon-based material on the magnetic layer. Then, a lubricating oil is applied on the protective layer to form a lubricating layer. A magnetic disk can be thus obtained.

### Examples

Examples of aluminum alloy sheets and their manufacturing methods, and aluminum alloy substrates made from the aluminum alloy sheets and their manufacturing methods are described below. Specific modes of the aluminum alloy sheets and their manufacturing methods, and the aluminum alloy substrates made from the aluminum alloy sheets and their manufacturing methods are not limited to the modes of the examples shown below, and the configurations can be changed as appropriate without departing from the scope and spirit of the disclosure.

(1) Preparation of Aluminum Alloy Sheet

Aluminum alloy sheets used for evaluation in the examples were prepared in the manner as described below. First, molten metal containing the chemical components shown in Table 1 was prepared in a melting furnace. Alloys other than B1 used aluminum bullion with the B content of 0.0015% or less (not 0.0000%), while the B1 alloy used aluminum bullion with the B content of 0.0025%.

TABLE 1

| | | alloy composition (mass %) | | | | | | | | | | | | | |
|---|---|---|---|---|---|---|---|---|---|---|---|---|---|---|---|
| | | | | | | | | | | | | | | | Al + |
| | | | | | | | | | | | | | | | unavoidable |
| | alloy No. | Si | Fe | Cu | Mn | Mg | Cr | Zn | Ti | Zr | Be | Sr | Na | P | impurities |
| Ex. 1 | A1 | 0.021 | 0.023 | 0.006 | 0.00 | 2.0 | 0.00 | 0.00 | 0.0003 | 0.00 | 0.0002 | 0.00 | 0.00 | 0.000 | balance |
| Ex. 2 | A2 | 0.020 | 0.020 | 0.007 | 0.00 | 4.0 | 0.05 | 0.32 | 0.0010 | 0.00 | 0.0003 | 0.00 | 0.00 | 0.000 | balance |
| Ex. 3 | A3 | 0.000 | 0.014 | 0.020 | 0.00 | 5.9 | 0.05 | 0.31 | 0.0021 | 0.00 | 0.0009 | 0.00 | 0.00 | 0.000 | balance |
| Ex. 4 | A4 | 0.036 | 0.044 | 0.013 | 0.19 | 2.9 | 0.05 | 0.29 | 0.0002 | 0.00 | 0.0002 | 0.00 | 0.00 | 0.000 | balance |
| Ex. 5 | A5 | 0.018 | 0.022 | 0.014 | 0.00 | 4.0 | 0.00 | 0.32 | 0.0011 | 0.00 | 0.0002 | 0.00 | 0.00 | 0.000 | balance |
| Ex. 6 | A6 | 0.015 | 0.019 | 0.056 | 0.00 | 4.1 | 0.04 | 0.49 | 0.0009 | 0.00 | 0.0009 | 0.00 | 0.00 | 0.000 | balance |
| Ex. 7 | A7 | 0.513 | 0.491 | 0.014 | 0.00 | 4.0 | 0.05 | 0.31 | 0.0018 | 0.00 | 0.0003 | 0.00 | 0.00 | 0.000 | balance |
| Ex. 8 | A8 | 0.322 | 0.443 | 0.223 | 1.04 | 1.2 | 0.00 | 0.15 | 0.0272 | 0.00 | 0.0000 | 0.00 | 0.00 | 0.000 | balance |
| Ex. 9 | A9 | 0.018 | 0.018 | 0.017 | 0.00 | 5.0 | 0.05 | 0.36 | 0.0016 | 0.15 | 0.0000 | 0.00 | 0.00 | 0.000 | balance |
| Ex. 10 | A10 | 0.104 | 0.187 | 0.012 | 0.00 | 4.0 | 0.05 | 0.33 | 0.0029 | 0.00 | 0.0006 | 0.02 | 0.01 | 0.001 | balance |
| Com. Ex. 1 | B1 | 0.020 | 0.020 | 0.014 | 0.00 | 4.0 | 0.05 | 0.32 | 0.0009 | 0.00 | 0.0003 | 0.00 | 0.00 | 0.000 | balance |
| Com. Ex. 2 | B2 | 0.020 | 0.020 | 0.014 | 0.00 | 4.0 | 0.05 | 0.32 | 0.0006 | 0.00 | 0.0003 | 0.00 | 0.00 | 0.000 | balance |
| Com. Ex. 3 | B3 | 0.023 | 0.018 | 0.016 | 0.00 | 0.0 | 0.00 | 0.29 | 0.0004 | 0.00 | 0.0000 | 0.00 | 0.00 | 0.000 | balance |
| Com. Ex. 4 | B4 | 0.020 | 0.020 | 0.016 | 0.00 | 15.0 | 0.00 | 0.34 | 0.0053 | 0.00 | 0.0015 | 0.00 | 0.00 | 0.000 | balance |

Next, the molten metal in the melting furnace was transferred, and an ingot was prepared by a casting method shown in Table 2 below. Then, the surface of the ingot was subjected to facing to remove a segregation layer present on the surface of the ingot. After the facing, the ingot was heated under the conditions shown in Table 2 for homogenization. Then, hot rolling was performed under the conditions shown in Table 2 to obtain a hot rolled sheet. Further, cold rolling was performed under the conditions shown in Table 2 to obtain a cold rolled sheet. For the materials other than B2, protective covers were installed at the distances shown in Table 2 from the rollers, for example, for hot rolling and cold rolling. For B2, aluminum alloy sheets were prepared without installation of protective covers.

(2) Preparation of Aluminum Alloy Substrate

The aluminum alloy sheet was punched to obtain a disk blank with an outer diameter of 98 mm and an inner diameter of 24 mm, and having a circular shape. Next, the obtained disk blank was pressurized from both sides in the thickness direction while being kept at 320° C. for 3 hours for pressure annealing. Further, the outer and inner end faces of each disk blank after pressure annealing were cut so that the disk blank was processed to have an outer diameter of 97 mm and an inner diameter of 25 mm. Then, the surface of each disk blank was ground so that the amount of grinding was 10 Thus, a test material of the aluminum alloy substrate was prepared.

(3) Evaluation of Distribution of Si—K—O-Based Particles and Ti—B-Based Particles

A method to assess the numbers of Si—K—O-based particles and Ti—B-based particles in the test materials described above is described below. The alloy of No. B3 contained 0.0% Mg and had too low strength, and thus is deformed during cutting or other processing, which could not be used for magnetic disks. The alloy of No. B4 had too many amount of Mg and too high strength, resulting in products with cracks during rolling, which could not be used for magnetic disks. Therefore, Comparative Examples 3 and 4 using the alloys of Nos. B3 and B4 did not perform evaluation for distribution of Si—K—O-based particles and Ti—B-based particles.

Si—K—O-based particles and Ti—B-based particles in the test materials were observed by SEM. However, the observation range of SEM is about several hundreds of μm². Thus, when the number of Si—K—O-based particles and Ti—B-based particles with a longest diameter of 1 μm or more present on the aluminum alloy-based surface is extremely small, measurement of the number of Si—K—O-based particles and Ti—B-based particles based on the observation of the surface of the test materials using a SEM is not practicable. Therefore, in the present example, the numbers of Si—K—O-based particles and Ti—B-based particles with a longest diameter of 1 μm or more in the test materials were measured by the following method.

When any coarse Si—K—O-based particles or Ti—B-based particles are not present on the surface of the aluminum alloy sheet, no scratches caused by coarse Si—K—O-based particles and Ti—B-based particles are formed on the surface of the aluminum alloy substrate during cutting and grinding, and thus an aluminum alloy substrate having a smooth surface can be obtained. As a result, plating pits are also unlikely to be formed on the Ni—P plating film formed on the aluminum alloy substrate.

On the other hand, when coarse Si—K—O-based particles and Ti—B-based particles are present on the surface of the aluminum alloy sheet, scratches caused by the coarse Si—K—O-based particles and Ti—B-based particles were formed on the surface of the aluminum alloy substrate during cutting and grinding. As a result, plating pits are likely to be formed on the Ni—P plating film on the aluminum alloy substrate at positions directly above the scratches on the surface of the aluminum alloy substrate.

Therefore, the presence of scratches formed during cutting and grinding was first determined by visually observing the surface of each test material of the aluminum alloy substrates. Next, using test materials having scratches on their surface, scratches and their surroundings were observed by SEM, and the surface was subjected to a surface analysis using EDS. Finally, based on the SEM images obtained from the surface analysis, the presence of Si—K—O-based particles and Ti—B-based particles on the surface of the test materials, and the longest diameters and the numbers of Si—K—O-based particles and Ti—B-based particles were determined.

The results are shown in Table 2. Table 2 shows the numbers of Si—K—O-based particles and Ti—B-based particles having a longest diameter of 1 μm or more and present on the surface of each test material, or the numbers of Si—K—O-based particles and Ti—B-based particles with a longest diameter of 1 m or more present on the surface of the aluminum alloy substrate, which are converted into numbers per 6,000 mm².

TABLE 2

| | | | | | hot rolling | hot rolling | sheet thickness |
|---|---|---|---|---|---|---|---|
| | | | homogenization | homogenization | starting | ending | after hot |
| | | | temperature | time period | temperature | temperature | rolling |
| | alloy No. | casting method | (° C.) | (h) | (° C.) | (° C.) | (mm) |
| Ex. 1 | A1 | metal mold casting | 540 | 3 | 540 | 280 | 3 |
| Ex. 2 | A2 | DC casting | 550 | 4 | 450 | 350 | 3 |
| Ex. 3 | A3 | DC casting | 530 | 4 | 530 | 280 | 3.8 |
| Ex. 4 | A4 | DC casting | 570 | 4 | 570 | 280 | 3 |
| Ex. 5 | A5 | DC casting | 540 | 4 | 450 | 280 | 3 |
| Ex. 6 | A6 | metal mold casting | 540 | 4 | 540 | 280 | 3.8 |
| Ex. 7 | A7 | metal mold casting | 540 | 4 | 540 | 280 | 3.8 |
| Ex. 8 | A8 | DC casting | 600 | 3 | 600 | 280 | 3.8 |
| Ex. 9 | A9 | metal mold casting | 530 | 4 | 530 | 280 | 3.8 |
| Ex. 10 | A10 | metal mold casting | 540 | 4 | 540 | 280 | 3 |
| Com. Ex. 1 | B1 | DC casting | 550 | 4 | 450 | 350 | 3 |
| Com. Ex. 2 | B2 | DC casting | 550 | 4 | 450 | 350 | 3 |
| Com. Ex. 3 | B3 | DC casting | 510 | 1 | 510 | 280 | 3 |
| Com. Ex. 4 | B4 | metal mold casting | 320 | 2 | 320 | — | — |

| | | sheet | distance | pressure | distribution of | distribution of |
|---|---|---|---|---|---|---|
| | total draft | thickness after | between roll and | annealing | Ti—B-based | Si—K—O-based |
| | in cold rolling | cold rolling | protective cover | temperature | particles | particles |
| | (%) | (mm) | (m) | (° C.) | (number/6000 mm²) | (number/6000 mm²) |
| Ex. 1 | 75 | 0.74 | 5 | 320 | 0 | 0 |
| Ex. 2 | 75 | 0.74 | 2 | 320 | 0 | 0 |
| Ex. 3 | 65 | 1.32 | 5 | 320 | 0 | 0 |
| Ex. 4 | 75 | 0.74 | 5 | 320 | 0 | 0 |
| Ex. 5 | 57 | 1.3 | 5 | 320 | 0 | 0 |
| Ex. 6 | 65 | 1.32 | 5 | 320 | 0 | 0 |
| Ex. 7 | 65 | 1.32 | 5 | 320 | 0 | 0 |
| Ex. 8 | 65 | 1.32 | 5 | 320 | 0 | 0 |
| Ex. 9 | 66 | 1.29 | 5 | 320 | 0 | 0 |
| Ex. 10 | 75 | 0.74 | 5 | 320 | 0 | 0 |
| Com. Ex. 1 | 75 | 0.74 | 2 | 320 | 2 | 0 |
| Com. Ex. 2 | 75 | 0.74 | — | 320 | 0 | 2 |
| Com. Ex. 3 | 70 | 0.89 | 5 | 320 | — | — |
| Com. Ex. 4 | — | — | 5 | — | — | — |

As shown in Table 2, Examples 1 to 10 had specific alloy compositions as defined in the claims, with the numbers of Si—K—O-based particles and Ti—B-based particles with a longest diameter of 1 μm or more exposed on the surface of the test materials being equal to or less than 1/6,000 mm². Thus, these Examples can reduce the formation of plating pits during the electroless Ni—P plating process, improving the smoothness of the Ni—P plating film.

On the other hand, Comparative Example 1, because of using an alloy of No. B1 containing 0.0025% B, showed many coarse Ti—B-based particles. The coarse Ti—B-based particles fell off in the process of producing the aluminum alloy substrate, causing dents and scratches on the surface. Thus, in Comparative Example 1, after the aluminum alloy substrate produced from an alloy of No. B1 was subjected to an electroless Ni—P plating process, many number of plating pits would be present, reducing the smoothness of the Ni—P plating film.

In Comparative Example 2, since the B2 aluminum alloy sheet was produced without providing a protective cover, dust or the like from the surrounding environment was adhered to and embedded in the surface of the aluminum alloy sheet, so that many coarse Si—K—O-based particles were present. The coarse Si—K—O-based particles fell off in the process of producing the aluminum alloy substrate, causing dents and scratches on the surface. Thus, in Comparative Example 2, after the aluminum alloy substrate produced from an alloy of No. B2 was subjected to an electroless Ni—P plating process, many number of plating pits would be present, reducing the smoothness of the Ni—P plating film.

As described above, Comparative Examples 3 and 4 using the alloys of Nos. B3 and B4 did not perform evaluation for distribution of Si—K—O-based particles and Ti—B-based particles.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the disclosure is defined only by the included claims, along with the full range of equivalents to which such claims are entitled.

This application claims the benefit of Japanese Patent Application No. 2020-068369, filed on Apr. 6, 2020, the entire disclosure of which is incorporated by reference herein.

### INDUSTRIAL APPLICABILITY

The present disclosure can also provide an aluminum alloy substrate for magnetic disks on which a Ni—P plating film can be formed with less plating pits and higher smoothness by preventing production of coarse Si—K—O-based particles and Ti—B-based particles on the surface, and thereby reducing damage to the substrate surface due to falling off of these particles.

1. An aluminum alloy substrate for magnetic disks, comprising an aluminum alloy containing:
1.0 to 6.5 mass % of Mg; and
the balance consisting of Al and unavoidable impurities,
wherein
the distribution of Si—K—O-based particles with a longest diameter of 1 μm or more adhering to the surface from the surrounding environment is equal to or less than one particle/6,000 mm², and
the distribution of Ti—B-based particles with a longest diameter of 1 μm or more present on the surface is equal to or less than one particle/6,000 mm².

2. The aluminum alloy substrate for magnetic disks according to claim 1, wherein the aluminum alloy further contains one or more selected from the group consisting of 0.300 mass % or less of Cu, 0.60 mass % or less of Zn, 0.600 mass % or less of Fe, 0.600 mass % or less of Si, 0.0020 mass % or less of Be, 0.20 mass % or less of Cr, 1.70 mass % or less of Mn, 0.20 mass % or less of Zr, 0.10 mass % or less of Sr, 0.10 mass % or less of Na, and 0.10 mass % or less of P.

3. A magnetic disk comprising:
an aluminum alloy substrate for magnetic disks according to claim 1 or 2;
an electroless Ni—P plated layer provided on the surface of the aluminum alloy substrate; and
a magnetic layer provided on the electroless Ni—P plated layer.
